(19) United States
(12) Patent Application Publication
(10) Pub. No.: US 2010/0039556 A1
(43) Pub. Date: Feb. 18, 2010

(54) MULTI-RESOLUTION TEMPORAL DEINTERLACING

(75) Inventors: Oscar Chi Lim Au, Hong Kong (CN); Tak Song Chong, Hong Kong (CN); Shing Fat Tu, Hong Kong (CN)

Correspondence Address: TUROCY & WATSON, LLP, 127 Public Square, 57th Floor, Key Tower, CLEVELAND, OH, 44114, US

(73) Assignee: THE HONG KONG UNIVERSITY OF SCIENCE AND TECHNOLOGY, Hong Kong (CN)

(21) Appl. No.: 12/190,140

(22) Filed: Aug. 12, 2008

(51) Int. Cl. H04N 7/01

(52) U.S. Cl. 348/452; 348/E07.003; 348/E05.109

(57) ABSTRACT

System and methodologies are provided herein for de-interlacing a video sequence. Various aspects described herein can utilize a motion adaptive video de-interlacing algorithm based on block-based texture classification and a multi-level decision hierarchy to interpolate missing fields of an interlaced video signal in the spatial and temporal domains. In accordance with various aspects described herein, respective blocks of an interlaced video sequence can be classified by a texture classifier as “textured” or “non-textured.” Based on this classification, one or more motion detection schemes can be utilized to determine whether the respective blocks are static or moving. Missing pixels from one or more blocks can then be estimated using the texture and motion classifications based on values of neighboring lines and/or pixels in the field from which the block was obtained as well as values of corresponding pixel locations in temporally adjacent fields.

### TECHNICAL FIELD

The subject disclosure relates generally to video signal processing, and more particularly to techniques for video de-interlacing.

### BACKGROUND

Traditionally, interlaced video has been commonly used in the field of video distribution due to the fact that it can reduce large area flicker without an increase in transmission bandwidth. This is accomplished by, for example, assigning alternating horizontal lines in a video signal of N lines to two fields of N/2 lines and alternating transmitted video information between the first field and the second field. Interlaced video has been widely adopted for use with both analog video distribution, such as television transmission in the Phase Alternating Line (PAL), National Television Standards Committee (NTSC) and Sequential Couleur Avec Memoire (SECAM) standards, and digital video distribution, such as digital television (DTV), network-based and Internet-based video broadcast. However, video interlacing can introduce several visual artifacts such as edge flicker, interline flicker, and line crawling.

In contrast to interlaced video, progressive video is broadcasted as a series of frames respectively comprising a single, undivided field. Accordingly, progressive has been adopted by the personal computer (PC) and Internet broadcasting communities as well as some DTV broadcasters due to reductions in visual artifacts and image processing complexity as compared to interlaced video. Further, a growing number of television sets, such as Liquid Crystal Display (LCD) televisions and the like, utilize progressive scanning video display technology. Thus, in order to provide compatibility between interlaced video standards and progressive scanning video devices, de-interlacing techniques are often utilized by progressive scanning devices to convert interlaced video to progressive video.

Some existing video de-interlacing algorithms utilize spatial interpolation to convert interlaced video to progressive video, wherein data from lines and/or pixels neighboring an omitted line are utilized to interpolate the missing video data. However, such techniques are often ineffective for various classes of objects that can vary significantly within adjacent lines, such as subtitles and/or other written characters. Accordingly, there exists a need for video de-interlacing techniques that mitigate at least the above shortcomings.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject disclosure provides systems and methodologies for improved video de-interlacing. In accordance with various aspects, a motion adaptive video de-interlacing algorithm based on block-based texture classification and a multi-level decision hierarchy is utilized to interpolate missing fields of an interlaced video signal in the spatial and temporal domains. In connection with the motion adaptive video de-interlacing algorithm, various systems and/or methodologies described herein can employ a block-based texture classifier, a block-based motion detector, and/or a pixel-based interpolation kernel.

In accordance with one aspect, respective blocks of an interlaced video sequence can be classified by a texture classifier as “textured” or “non-textured.” Based on this classification, one or more motion detection schemes can be utilized to determine whether the respective blocks are static or moving. Missing or omitted pixels from one or more blocks can then be estimated based on values of neighboring lines and/or pixels in the frame from which the block was obtained as well as values of corresponding pixel locations in temporally adjacent frames. By utilizing temporal interpolation in combination with spatial interpolation in this manner, video de-interlacing performance can be significantly increased for written characters and/or other video elements that exhibit great variation within a small number of lines.

To the accomplishment of the foregoing and related ends, certain illustrative aspects of the claimed subject matter are described herein in connection with the following description and the annexed drawings. These aspects are indicative, however, of but a few of the various ways in which the principles of the claimed subject matter can be employed. The claimed subject matter is intended to include all such aspects and their equivalents. Other advantages and novel features of the claimed subject matter can become apparent from the following detailed description when considered in conjunction with the drawings.

### BRIEF DESCRIPTION OF THE DRAWINGS

FIG. 1 is a high-level block diagram of a system for communicating and processing a video signal in accordance with various aspects.

FIG. 2 is a block diagram of a system for de-interlacing a video sequence in accordance with various aspects.

FIG. 3 illustrates a motion adaptive de-interlacing system in accordance with various aspects.

FIG. 4 illustrates a system for spatially interpolating a pixel value in accordance with various aspects.

FIG. 5 illustrates a system for utilizing spatial and temporal interpolation to estimate a pixel value in accordance with various aspects.

FIG. 6 illustrates example weighting parameters for combining interpolation estimates in accordance with various aspects.

FIGS. 7-8 are flowcharts of respective methods for de-interlacing a video signal.

FIG. 9 is a flowchart of a method for estimating a pixel value using spatial interpolation.

FIG. 10 is a block diagram of an example operating environment in which various aspects described herein can function.

FIG. 11 is a block diagram of an example networked computing environment in which various aspects described herein can function.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Also, the methods and apparatus of the claimed subject matter, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the claimed subject matter. The components may communicate via local and/or remote processes such as in accordance with a signal having one or more data packets (e.g. data from one component interacting with another component in a local system, distributed system, and/or across a network such as the Internet with other systems via the signal).

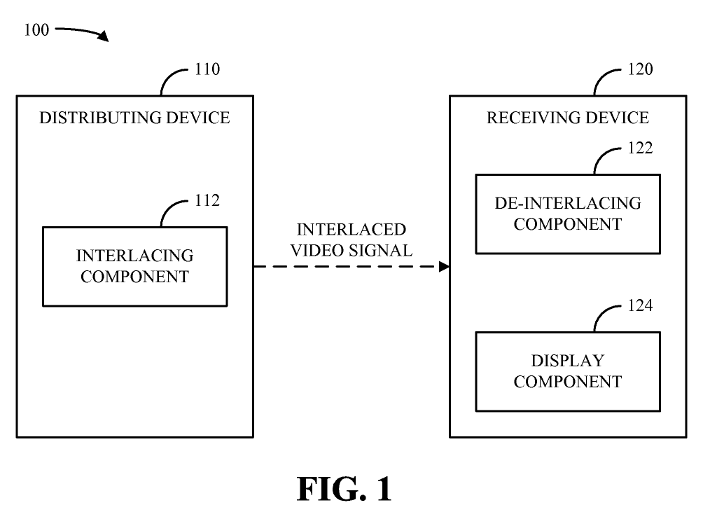

Referring to the drawings, FIG. 1 illustrates a high-level block diagram of a system 100 for communicating and processing a video signal in accordance with various aspects presented herein. In one example, system 100 includes a distributing device 110 that can provide one or more video signals to a receiving device 120. While only one distributing device 110 and one receiving device 120 are illustrated in system 100 for simplicity, it should be appreciated that system 100 can include any number of distributing devices 110 and/or receiving devices 120, each of which can communicate video signals to and/or from one or more devices 110 and/or 120.

By way of non-limiting example, a distributing device 110 can be a television transmitter that broadcasts one or more interlaced video signals using one or more analog broadcast technologies (e.g., NTSC, PAL, and/or SECAM) and/or digital broadcast technologies, and a receiving device 120 can be a television set, a set-top box or unit, and/or any other suitable device for receiving television signals. Additionally and/or alternatively, the distributing device 110 and receiving device 120 can be communicatively connected via a wired (e.g., Ethernet, IEEE-802.3, etc.) or wireless (IEEE-802.11, Bluetooth™, etc.) networking technology. Further, a distributing device 110 and a receiving device 120 can be directly connected to one another or indirectly connected through a third party device (not shown). For example, a distributing device 110 can be a television transmitter and a receiving device 120 can be a television or set-top unit that obtains a video signal from the distributing device 110 via one or more relay stations, television service providers, and/or other suitable intermediate entities. As another example, a receiving device 120 can be a mobile terminal that accesses video signals from the distributing device 110 via a cellular communication network such as the Global System for Mobile Communications (GSM), a Code Division Multiple Access (CDMA) communication system, and/or another suitable cellular communication network.

In accordance with one aspect, an interlacing component 112 can be utilized to interlace a video signal prior to distribution from a distributing device 110 to a receiving device 120. While the interlacing component 112 is illustrated in FIG. 1 as part of the distributing device 110, it should be appreciated that the interlacing component 112 can alternatively be external to the distributing device 110 and provide interlaced video signals to the distributing device 110 via a wired and/or wireless communication channel.

In one example, the interlacing component 112 can interlace a video sequence having a vertical resolution of N lines in a frame-by-frame manner by initially dividing the frame area of the video sequence into a predetermined number of non-overlapping fields. Consecutive frames can then be associated with alternating fields, such that the video sequence can be interlaced by removing image data in respective frames corresponding to a field(s) not associated with the respective frames. For example, in the case of an interlaced video sequence having two fields, horizontal lines in the frame area of the video sequence can be assigned to the two fields in an alternating fashion to create two fields of N/2 horizontal lines. Consecutive frames can then be associated with alternating fields such that, for example, a first frame contains only pixel data corresponding to the first field, a second frame contains only pixel data corresponding to the second field, a third frame contains only pixel data corresponding to the first field, and so on. It should be appreciated, however, that the value of N/2 need not be integral and that fields used for interlacing need not be equal in size. For example, in a non-limiting example similar to the NTSC broadcast standard, a frame containing 525 lines can be interlaced into two fields of 262.5 lines, a first field of 263 lines and a second field of 262 lines, and/or any other appropriate configuration.

Video interlacing, such as that performed by the interlacing component 112, was originally developed for use in connection with low-bandwidth analog television broadcasts to cathode ray tube (CRT)-based television sets. By exploiting properties of CRT displays and persistence of vision, video interlacing enables the display of a video signal at higher refresh rates, thereby reducing large area flicker, without an increase in required transmission bandwidth. However, a growing number of modern receiving devices 120 (e.g., television sets, computer monitors, etc.) are employing progressive scanning display technologies, such as, for example, LCD, Digital Light Processing (DLP), and Plasma Display Panel (PDP) technologies that are not compatible with interlaced video signals. Accordingly, to facilitate compatibility with interlaced video signals, the receiving device 120 can include a de-interlacing component 122, which can convert an interlaced video signal into a progressive video signal that can be displayed by the receiving device 120.

In accordance with one aspect, the de-interlacing component 122 can utilize a combination of spatial and temporal interpolation to perform motion adaptive video de-interlacing for one or more video sequences. In one example, the de-interlacing component can determine a perceived level of texture and/or motion in respective blocks of a video frame. These determinations can then be utilized to estimate values of respective pixels removed during interlacing by first determining whether spatial and/or temporal interpolation should be performed for a respective pixel and subsequently determining an extent to which the respective interpolations should be factored in the estimation for the pixel. By utilizing temporal interpolation in combination with spatial interpolation in this manner, video de-interlacing performance can be significantly increased for written characters and/or other video elements that exhibit great variation within a small number of lines. Techniques by which the de-interlacing component 122 can estimate missing video data are described in further detail infra.

In one example, a video signal de-interlaced by the de-interlacing component 122 can optionally be provided to a display component 124 at the receiving device 120 for display. The display component 124 and/or another suitable component associated with the receiving device 120 can additionally perform one or more appropriate adjustments and/or pre-processing operations on the reconstructed video signal prior to display.

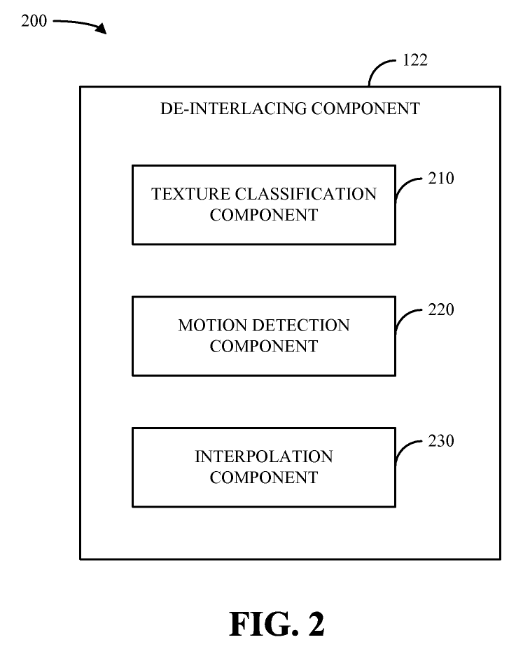

Referring now to FIG. 2, a block diagram of a system 200 for de-interlacing a video sequence is illustrated. As illustrated, system 200 can include a de-interlacing component 122, which can de-interlace one or more interlaced video sequences to generate respective progressive video sequences. In accordance with one aspect, the de-interlacing component 122 can utilize one or more motion adaptive de-interlacing techniques that estimate missing data in an interlaced video sequence in both the spatial and temporal domains. As noted above, video de-interlacing algorithms utilize only spatial interpolation are often ineffective for various classes of objects that can vary significantly within adjacent lines, such as subtitles and/or other written characters. By utilizing pixel data in immediately adjacent frames, which contain data corresponding to the field in which the missing data belongs due to the alternating nature of interlacing, as well as neighboring pixel data in the same frame, improved de-interlacing performance can additionally be realized for various classes of objects as compared to that realized using spatial interpolation alone.

In one example, motion adaptive de-interlacing can be performed by the de-interlacing component 122 by utilizing a block-based texture classification component 210, a block-based motion detection component 220, and a pixel-based interpolation component 230 as illustrated in system 200. In accordance with one aspect, frames of a video signal to be de-interlaced can be divided into blocks of a predetermined uniform size and provided to the texture classification component 210. The texture classification component 210 can then determine an amount of texture and/or smoothness in the respective blocks and classify the blocks based on this determination.

Based on this classification, the block can then be provided to a motion detection component 220 to determine whether the block contains moving objects. In one example, the motion detection component 220 can determine whether a block contains moving objects by comparing the block to corresponding blocks in preceding and/or following frames in the video sequence. Additionally and/or alternatively, the motion detection component 220 can utilize one or more of a variety of motion detection techniques for a particular block, which can be selected based on the classification of the block by the texture classification component 210.

Subsequent to the processing by the motion detection component 220, a block can be provided to an interpolation component 230, which can utilize a combination of spatial and temporal interpolation to estimate missing pixel values encountered in the block due to interlacing. In one example, the interpolation component 230 can utilize the respective classifications by the texture classification component 210 and the motion detection component 220 to determine whether to use spatial interpolation, temporal interpolation, or both for a given block. If it is determined to use both spatial and temporal interpolation, the interpolation component 230 can additionally use the respective classifications to determine weights and/or blending factors to apply to its spatial and temporal interpolations in order to arrive at a final estimate for the missing pixels in the block. Examples of techniques that can be utilized by components 210-230 in performing motion adaptive de-interlacing are described in further detail with respect to the drawings that follow.

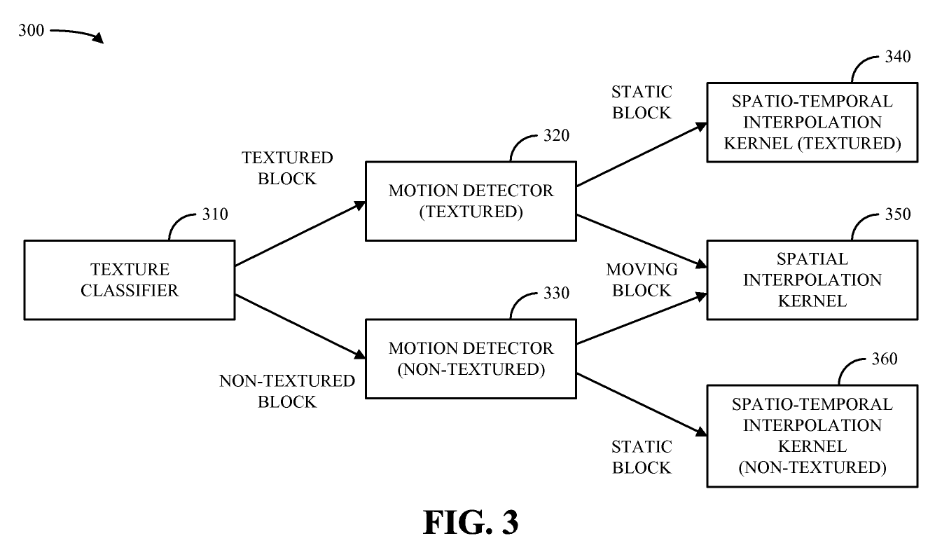

FIG. 3 illustrates an example of a motion adaptive de-interlacing system 300 in accordance with various aspects. In one example, system 300 can include a block-based texture classifier 310, block-based motion detectors 320 and 330, and pixel-based interpolation kernels 340-360. In accordance with one aspect, system 300 can generally operate as follows. First, respective interlaced video frames, which as described above contain data corresponding to a single field, are separated into blocks of size M×N pixels, herein denoted as B(i, j). Upon separation, each block can be processed by the texture classifier 310. If the texture classifier determines that a block has more than a predetermined threshold amount of texture, the block is classified as “textured” and processed by the textured block motion detector 320. Otherwise, the block is processed by the non-textured block motion detector 330. At motion detector 320 or 330, it is next detected whether the block B(i, j) is in motion. If the block is determined to be in motion, a spatial interpolation kernel 350 is used to reconstruct the missing field. Otherwise, a textured block spatio-temporal interpolation kernel 340 or a non-textured block spatio-temporal interpolation kernel 360 is applied to the block to estimate the missing field based on the classification of the block by the texture classifier 310.

In one example, separate motion detectors 320 and 330 and separate spatio-temporal interpolation kernels 340 and 360 are respectively utilized for textured blocks and non-textured blocks due to differences in characteristics between textured and non-textured blocks. For example, if a block is smooth (e.g. non-textured), spatial interpolation provides a reasonably accurate estimate of the missing field. Thus, the non-textured block motion detector 330 can make use of spatial interpolation to determine whether a block is stationary. Additionally, the non-textured block interpolation kernel 360 can give a larger weighting to the result of spatial interpolation for the block. On the other hand, if the block contains a substantially large amount of texture, such as horizontal lines and/or images with textures one pixel in height, the result of spatial interpolation may be less accurate. Accordingly, the textured block motion detector 320 and interpolation kernel 340 can de-emphasize the result of spatial interpolation for the block.

In accordance with one aspect, the texture classifier 310 can process a block B(i, j) as follows. First, f(x,y,t) can be defined as pixel intensity at position (x,y). It can be appreciated that f(x,y,t) is available if y mod 2=t mod 2. Accordingly, block variance Var(B) can be defined as follows:

$$Var ( B ) = {\sum }_{{( x , y ) ∈ B and}_{y mod 2 = t mod 2}} f ( x , y , t ) - \overline{B} , \qquad ( 1 )$$

where B̅ is the average intensity of block B, which is defined as follows:

$$\overline{B} = {\sum }_{{( x , y ) ∈ B and}_{y mod 2 = t mod 2}} f \frac{( x , y , t )}{MN} . \qquad ( 2 )$$

Further, the amount of horizontal pixels in a block can be defined as follows:

$$Hor ( B ) = {\sum }_{{( x , y ) ∈ B and}_{y mod 2 \neq t mod 2}} H ( x , y ) , \qquad ( 3 )$$

Where H(x,y) is equal to 1 if the following conditions are met for predefined thresholds T₁ and T₂ or equal to 0 otherwise:

$$\begin{matrix}\vert 2 f ( x - 1 , y ) - f ( x - 1 , y - 1 ) - f ( x - 1 , y + 1 ) \vert + \vert 2 f ( x + 1 , y ) - f ( x + 1 , y - 1 ) - f ( x + 1 , y + 1 ) \vert < {T}_{1} , and & ( 4 ) \\ {\sum }_{m = - 1}^{1} \vert f ( x - 1 , y + m ) - f ( x + 1 , y + m ) \vert > {T}_{2} . & ( 5 )\end{matrix}$$

Based on the above calculations, in one example the texture classifier 310 can then classify a block as textured if Var(B)>T₁ or Hor(B)>T₂.

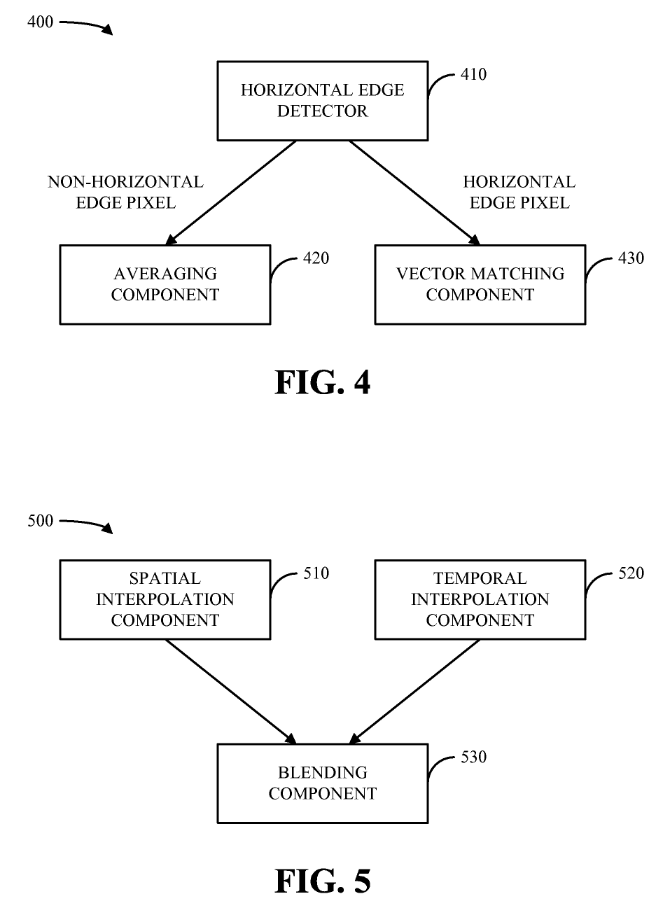

As noted above, if a block is classified as textured, it can be provided to the textured block motion detector 320 for further processing. In accordance with one aspect, the textured block motion detector 320 can operate as follows. Initially, to determine whether a block is in motion, the sum of absolute differences (SAD) with a zero motion vector can be calculated. In one example, a set of three SAD calculations can be performed as follows:

$$\begin{matrix}S A {D}_{1} ( B ) = {\sum }_{{( x , y ) ∈ B and}_{y mod 2 \neq t mod 2}} \vert f ( x , y , t - 1 ) - {\hat{f}}_{s} ( x , y , t ) \vert , & ( 6 ) \\ S A {D}_{2} ( B ) = {\sum }_{{( x , y ) ∈ B and}_{y mod 2 \neq t mod 2}} \vert f ( x , y , t + 1 ) - {\hat{f}}_{s} ( x , y , t ) \vert , & ( 7 ) \\ S A {D}_{3} ( B ) = {\sum }_{{( x , y ) ∈ B and}_{y mod 2 \neq t mod 2}} \vert f ( x , y , t + 1 ) - f ( x , y , t - 1 ) \vert , & ( 8 )\end{matrix}$$

where \hat{f}ₛ(x,y,t) is an initial field construction based on spatial interpolation. Techniques for performing spatial interpolation for a field are described in further detail infra with regard to the spatial interpolation kernel 350 and FIG. 4.

From Equations (6)-(8), the textured block motion detector 320 can determine a final SAD SAD₁ (B) as follows:

$$S A {D}_{I} ( B ) = \frac{S A {D}_{1} ( B ) + S A {D}_{2} ( B )}{2} + S A {D}_{3} ( B ) . \qquad ( 9 )$$

Based on Equation (9), a block can be defined as a moving block if SAD₁(B)>T₃ for a predefined threshold T₃.

In accordance with another aspect, the non-textured block motion detector 330 can be utilized for blocks classified as non-textured by the texture classifier 310. In one example, operation of the non-textured block motion detector 330 can differ from the operation of the textured block motion detector 320 described above by placing greater emphasis on the spatially interpolated field. It can be observed that for smooth regions, spatial interpolation alone often provides reasonably accurate results. Accordingly, the non-textured block motion detector 330 can calculate values of SAD₁(B) and SAD₂(B) as provided in Equations (6) and (7) above and ignore the value of SAD₃(B) for simplicity. The final SAD SADᵤ(B) for the non-textured block motion detector 330 can then be defined as follows:

$$S A {D}_{II} ( B ) = \frac{S A {D}_{1} ( B ) + S A {D}_{2} ( B )}{2} , \qquad ( 10 )$$

and a block can be defined as a moving block if SADᵤ(B)>T₄ for a predefined threshold T₄.

In one example, if a block is defined as moving by a motion detector 320 or 330, the block can be provided to the spatial interpolation kernel 350, where pure spatial interpolation can be used to reconstruct the missing field of the block. In accordance with one aspect, spatial interpolation as utilized by motion detectors 320 and/or 330 as well as interpolation kernels 340-360 can be performed using a content adaptive de-interlacing (CADI) technique as illustrated by system 400 in FIG. 4.

As FIG. 4 illustrates, system 400 can include a horizontal edge detector 410, a vector matching component 420, and an averaging component 430 that can perform pixel-based spatial interpolation for an interlaced video block and/or frame. In one example, the horizontal edge detector 410 can utilize high pass filtering based on Equations (4) and (5) above and/or another suitable mechanism to detect whether a pixel belongs to a horizontal edge. Based on this determination, spatial interpolation can be performed by an averaging component 420 for pixels determined not to be in a horizontal edge and/or by a vector matching component 430 for pixels determined to be in a horizontal edge.

In accordance with one aspect, the averaging component 420 can utilize one or more averaging algorithms to interpolate a missing pixel, such as vertical averaging, edge-based line averaging (ELA) or a variant thereof, and/or any other suitable algorithm. In one example, an algorithm can be selected for use by the averaging component 420 based on a classification by the texture classifier 310 for a block containing a pixel to be processed. For example, vertical averaging can be utilized for non-textured blocks and ELA can be utilized for textured blocks.

In one example, the averaging component 420 can utilize a modified ELA algorithm to interpolate a missing pixel as follows. First, a correlation measurement for a direction k can be expressed as a function C(k), which can be defined as follows:

$$C ( k ) = {\sum }_{m = x - 1}^{x + 1} {( f ( y - 1 , m - k ) - f ( y + 1 , m + k ) )}^{2} . \qquad ( 11 )$$

As can be observed from Equation (11), the measurement C(k) represents intensity change in the candidate direction k. The modified ELA has a higher accuracy over traditional ELA because it considers the intensity change in neighboring pixels and gives a more consistent estimated edge direction. Accordingly, the estimated edge direction or interpolation direction D is the direction that minimizes C(k), such that:

$$D = arg {min}_{- R \leq k \leq R} ( C ( k ) ) , \qquad ( 12 )$$

for a predefined search range R. Subsequently, the missing pixel f(x,y) can be interpolated by simple averaging along the edge direction as follows:

f(x,y)=(f(x−D,y−1)+f(x+D,y+1))/2. (13)

In accordance with another aspect, the vector matching component 430 can interpolate missing pixels found to be on a horizontal edge by the horizontal edge detector 410 using a vector matching algorithm. In one example, the vector matching algorithm utilized by the vector matching component 410 can employ an adaptive search range and utilize a set of various features to improve de-interlacing performance, such as search range estimation for estimating a minimum required search range, grouping consecutive pixels in an edge into a single matching vector for directional correlation estimation, and checking the consistency of horizontal edge information in each candidate direction.

In one example, vector matching can be performed as a two-step process. First, search range estimation is performed, wherein the minimum required search range for direction estimation is estimated. Next, constrained direction estimation is performed, which exploits the directional correlation of the matching vector along the reliable candidate directions.

Search range estimation can be performed by the vector matching component 430 as follows. For a horizontal edge with gradient 1:G, it can be appreciated that the best search range should be equal to or larger than the gradient G as the pixels are more correlated along the edge direction. As a result, if the search range R is smaller than gradient G, the best interpolating direction cannot be detected and poor interpolation performance can result. In one example, for a horizontal edge region of L pixels, the gradient G and L can have the following relation:

L=2G−2. (14)

Accordingly, since the search range R should be greater than or equal to gradient G, the minimum required search range R can be found as follows:

R=(L+2)/2. (15)

After determining an appropriate search range, the vector matching component 430 can perform constrained direction estimation as follows. In one example, pixels in a horizontal edge region are combined into a matching vector v during constrained direction estimation. Thus, for consecutive pixels in the horizontal edge region, a row vector can be formed as follows:

v=[f(x₁,y) f(x₁+1,y) f(x₁+2,y) . . . f(x₂,y)], (16)

Where (x₁, y) and (x₂, y) are the leftmost and rightmost pixels in the horizontal edge region, respectively. In addition, an upper reference vector U(k) and a lower reference vector L(k) can be defined as follows:

U(k)=[f(x₁−k,y−1) f(x₁+1−k,y−1) . . . f(x₂−k,y−1)], (17)

L(k)=[f(x₁+k,y+1) f(x₁+1+k,y+1) . . . f(x₂+k,y+1)]. (18)

Based on the above, the correlation measurement C(k) can be defined as follows:

C(k)=|U(k)−L(k)|², (19)

where |.| denotes vector norm. The estimated edge direction D can then be chosen to be the direction that minimizes C(k), such that:

$$D = arg {min}_{k ∈ S} ( C ( k ) ) , \qquad ( 20 )$$

Where k belongs to the set S if there exists a horizontal edge oriented in the direction k. This determination can be made as follows. First, p(x,y,k) can be defined as a horizontal edge consistency indicator, which can be set to 1 of any of the following conditions are met and 0 otherwise:

(H(x−2k,y−2)=1 and H(x−4k,y−4)=1) (21)

or (H(x−2k,y−2)=1 and H(x+2k,y+2)=1) (22)

or (H(x+2k,y+2)=1 and H(x+4k,y+4)=1), (23)

where H(x,y) is equal to 1 if Equations (4) and (5) are met for predefined thresholds T₁ and T₂ or equal to 0 otherwise. In one example, the horizontal edge consistency indicator examines the availability of a horizontal edge along the candidate direction k. It can be appreciated that Equation (21) is satisfied if there exists a horizontal edge that passes through the missing pixels in direction k while equations (22) and/or (23) are satisfied if the missing pixels are located at the end of a horizontal edge. Furthermore, the set S can be further constrained such that:

$$k ∈ S if {\sum }_{x = {x}_{1}}^{{x}_{2}} p ( x , y , k ) > wL and - R \leq k \leq R , \qquad ( 24 )$$

where wε[0,1] is a parameter to control the strictness of the consistency test.

In one example, to ensure a high directional correlation, the correlation measurement can be checked against a predefined threshold. If the minimum value of C(k) per pixel is smaller than the threshold, the vector matching component 430 can interpolate all the pixels in the matching vector v along the estimated edge direction D by simple averaging. Otherwise, the vector matching component 430 can utilize vertical averaging.

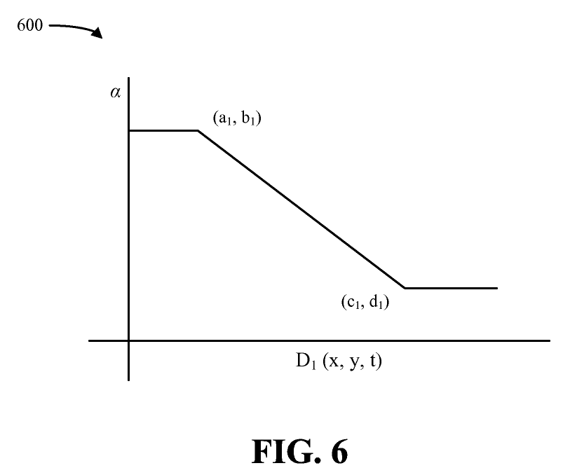

Referring back to FIG. 3, if a block is defined as static by a motion detector 320 or 330, the block can be provided to a respective spatio-temporal interpolation kernel 340 or 360, where a pixel-based interpolation scheme is utilized that blends a spatially interpolated value and a temporally interpolated value to achieve an optimal pixel estimate. By performing pixel-based decisions, it can be appreciated that the spatio-temporal interpolation kernels 340 and 360 are able to adapt to local image characteristics, thereby enabling higher-quality interpolation. In accordance with one aspect, spatio-temporal interpolation as utilized by the interpolation kernels 340 and 360 can be performed as illustrated by system 500 in FIG. 5. As illustrated by FIG. 5, system 500 can include a spatial interpolation component 510, which can perform spatial interpolation for a missing pixel as described above with regard to the spatial interpolation kernel 350 and system 400. System 500 also includes a temporal interpolation component 520, which can interpolate a missing pixel based on data from preceding and/or following fields. The results of the spatial interpolation component 510 and the temporal interpolation component 520 can then be combined by a blending component 530, which can additionally determine weights and/or blending factors to apply to the respective results to facilitate combining the results based on the respective determined weights.

In accordance with one aspect, the textured block spatio-temporal interpolation kernel 340 can interpolate a missing pixel according to the following equation:

\hat{f}(x,y,t)=(α·\hat{f}ₜ(x,y,t))+((1−α)·\hat{f}ₛ(x,y,t)), (25)

where \hat{f}(x,y,t) represents the final result, \hat{f}ₛ(x,y,t) represents a spatially interpolated pixel value, and \hat{f}ₜ(x,y,t) represents a temporally interpolated value using a zero motion vector, which can be defined as follows:

$${\hat{f}}_{t} ( x , y , t ) = \frac{f ( x , y , t - 1 ) + f ( x , y , t + 1 )}{2} . \qquad ( 26 )$$

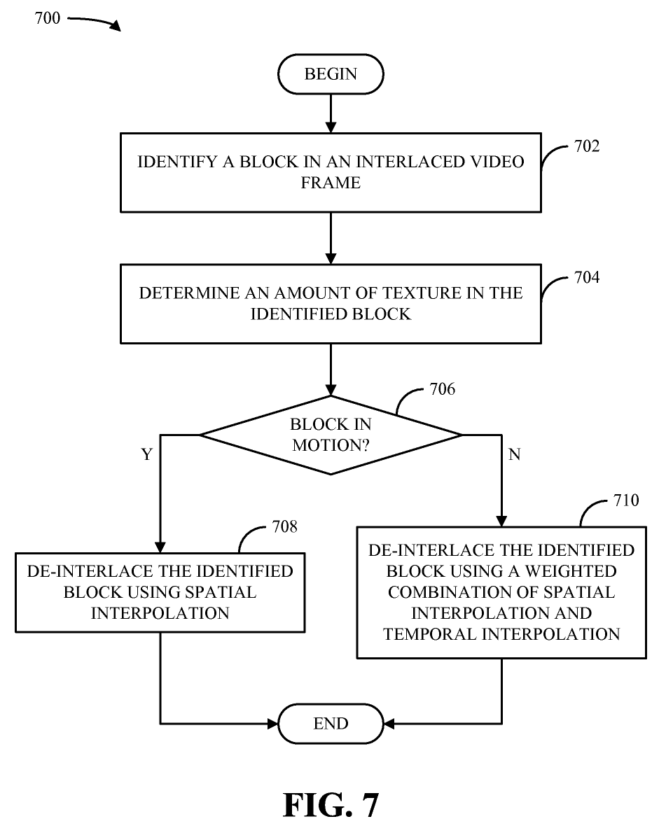

As additionally used in Equation (25), α is a blending parameter for the spatial interpolation and temporal interpolation results. In one example, the blending parameter α can be represented by graph 600 in FIG. 6, where D₁(x,y,t) is the temporal pixel difference between the previous field and the next field, which can be expressed as follows:

D₁(x,y,t)=|f(x,y,t−1)−f(x,y,t+1)|. (27)

In accordance with another aspect, the non-textured block spatio-temporal interpolation kernel 360 can operate in a similar manner to the textured block spatio-temporal interpolation kernel 340 with a difference in turning points for the blending parameter α. For example, the blending parameter a can be based on a temporal pixel difference D₂(x,y), which can be defined as follows:

D₂(x,y,t)=|fₛ(x,y,t)−fₜ(x,y,t)|. (28)

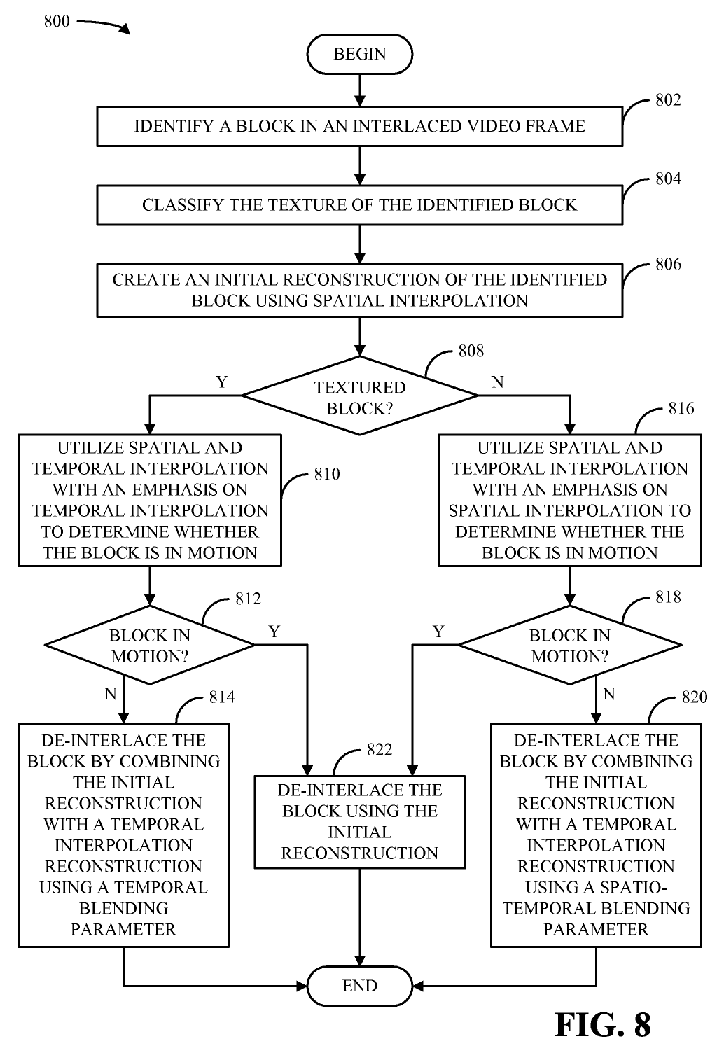

Referring now to FIGS. 7-9, methodologies that can be implemented in accordance with various aspects described herein are illustrated. While, for purposes of simplicity of explanation, the methodologies are shown and described as a series of blocks, it is to be understood and appreciated that the claimed subject matter is not limited by the order of the blocks, as some blocks may, in accordance with the claimed subject matter, occur in different orders and/or concurrently with other blocks from that shown and described herein. Moreover, not all illustrated blocks may be required to implement the methodologies in accordance with the claimed subject matter.

Furthermore, the claimed subject matter may be described in the general context of computer-executable instructions, such as program modules, executed by one or more components. Generally, program modules include routines, programs, objects, data structures, etc., that perform particular tasks or implement particular abstract data types. Typically the functionality of the program modules may be combined or distributed as desired in various embodiments. Furthermore, as will be appreciated various portions of the disclosed systems above and methods below may include or consist of artificial intelligence or knowledge or rule based components, sub-components, processes, means, methodologies, or mechanisms (e.g. support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

Referring to FIG. 7, a method 700 of de-interlacing a video signal in accordance with various aspects is illustrated. At 702, a block in an interlaced video frame is identified. At 704, an amount of texture is the block identified at 702 is determined (e.g., by a texture classification component 210). At 706, it is determined (e.g., by a motion detection component 220) whether the block is in motion. Following 706, interpolation can be performed (e.g., by an interpolation component 230) in two ways. If it is determined at 706 that the block is in motion, method 700 can proceed to 708, where the block is de-interlaced using spatial interpolation. Otherwise, method 700 proceeds to block 710, where the block is de-interlaced using a weighted combination of spatial and temporal interpolation.

FIG. 8 illustrates another method 800 for de-interlacing a video sequence. At 802, a block in an interlaced video frame is identified. At 804, the texture of the block identified at 802 is classified (e.g., by a texture classifier 310). At 806, an initial reconstruction of the block is created using spatial interpolation (e.g., by using system 400). At 808, it is then determined whether the block was classified as textured at 804. If the block was classified as textured at 804, method 800 continues to 810, where spatial and temporal interpolation are utilized (e.g., by a textured block motion detector 320) with an emphasis on temporal interpolation to determine whether the block is in motion. At 812, it is determined whether the block was found to be in motion at 810. If the block is determined not to be in motion at 812, method 800 concludes at 814, wherein the block is de-interlaced (e.g., by a textured block spatio-temporal interpolation kernel 340) by combining the initial reconstruction obtained at 806 with a temporal interpolation reconstruction using a temporal blending parameter. Otherwise, if the block is determined not to be in motion at 812, method 800 instead concludes at 822, wherein the block is de-interlaced (e.g., by a spatial interpolation kernel 350) using the initial reconstruction obtained at 806.

Referring back to 808, if the block is determined to be non-textured, method 800 can proceed to 816, wherein spatial and temporal interpolation are utilized (e.g. by a non-textured block motion detector 330) with an emphasis on spatial interpolation to determine whether the block is in motion. At 818, it is then determined whether the block was found to be in motion. Upon a positive determination at 818, method 800 concludes at 822 as described above. Otherwise, method 800 concludes at 820, wherein the block is de-interlaced (e.g. by a non-textured block spatio-temporal interpolation kernel 360) by combining the initial reconstruction obtained at 806 with a temporal interpolation reconstruction using a spatio-temporal blending parameter.

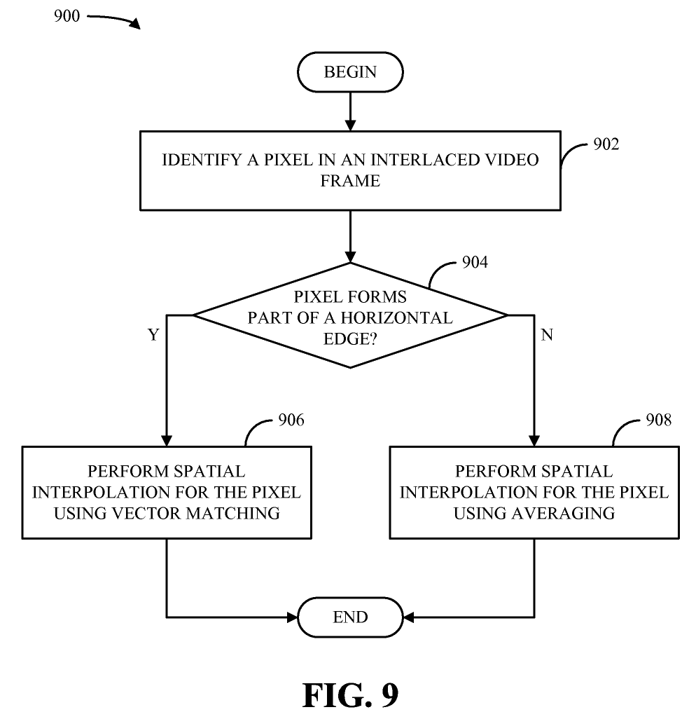

Turning now to FIG. 9, a method 900 for estimating a pixel value using spatial interpolation is illustrated. At 902, a pixel in an interlaced video frame is identified. At 904, it is determined (e.g., by a horizontal edge detector 410) whether the pixel identified at 902 forms part of a horizontal edge. If the pixel forms part of a horizontal edge, method 900 concludes at 906, where spatial interpolation for the pixel is performed using vector matching (e.g., via a vector matching component 430). Otherwise, method 900 concludes at 908, where spatial interpolation is performed for the pixel using averaging (e.g., via an averaging component 420).

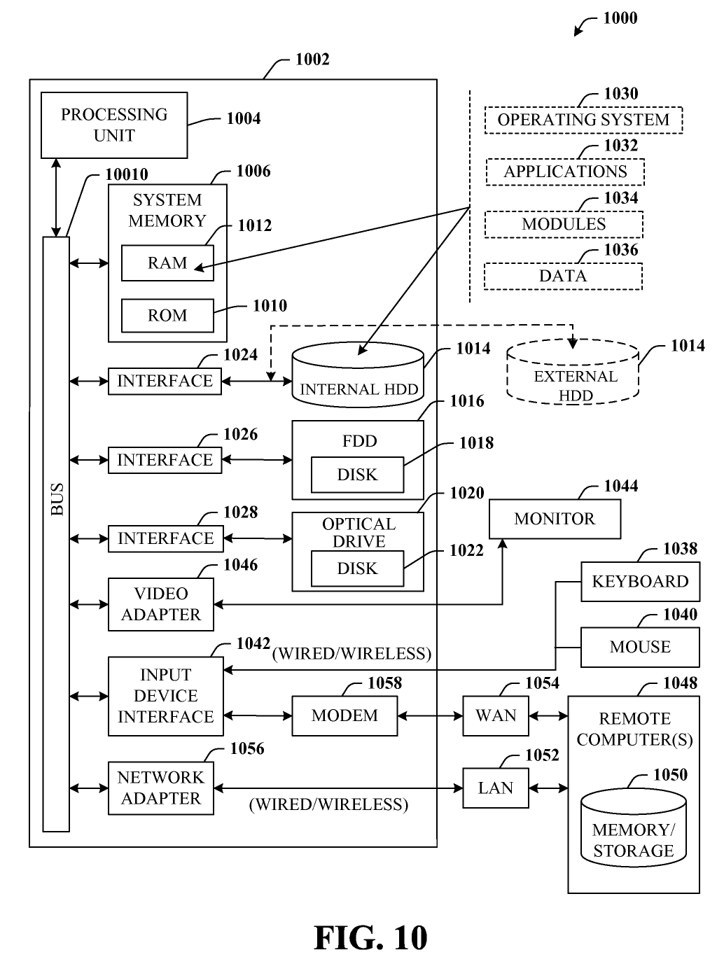

In order to provide additional context for various aspects described herein, FIG. 10 and the following discussion are intended to provide a brief, general description of a suitable computing environment 1000 in which various aspects of the claimed subject matter can be implemented. Additionally, while the above features have been described above in the general context of computer-executable instructions that may run on one or more computers, those skilled in the art will recognize that said features can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the claimed subject matter can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, an exemplary environment 1000 for implementing various aspects described herein includes a computer 1002, the computer 1002 including a processing unit 1004, a system memory 1006 and a system bus 1008. The system bus 1008 couples to system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE-1 394 interface technologies. Other external drive connection technologies are within contemplation of the subject disclosure.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the claimed subject matter can be implemented with various commercially available operating systems or combinations of operating systems.

A user can enter commands and information into the computer 1002 through one or more wired/wireless input devices, e.g. a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, a serial port, an IEEE-1394 port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g. a wide area network (WAN) 1054. Such LAN and WAN networking environments are commonplace in offices and companies, and facilitate enterprise-wide computer networks, such as intranets, all of which may connect to a global communications network, e.g. the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, is a wireless technology similar to that used in a cell phone that enables a device to send and receive data anywhere within the range of a base station. Wi-Fi networks use IEEE-802.11 (a, b, g, etc.) radio technologies to provide secure, reliable, and fast wireless connectivity. A Wi-Fi network can be used to connect computers to each other, to the Internet, and to wired networks (which use IEEE-802.3 or Ethernet). Wi-Fi networks operate in the unlicensed 2.4 and 5 GHz radio bands, at an 13 Mbps (802.11a) or 54 Mbps (802.11b) data rate, for example, or with products that contain both bands (dual band). Thus, networks using Wi-Fi wireless technology can provide real-world performance similar to a 10BaseT wired Ethernet network.

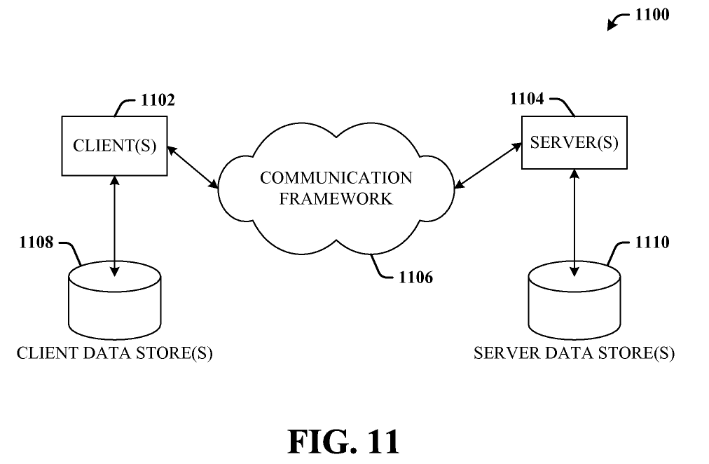

Referring now to FIG. 11, a schematic block diagram of an example networked computing environment in which various aspects described herein can function is illustrated. The system 1100 includes one or more client(s) 1102, which can be hardware and/or software (e.g. threads, processes, computing devices). In one example, the client(s) 1102 can house cookie(s) and/or associated contextual information.

The system 1100 can additionally include one or more server(s) 1104, which can also be hardware and/or software (e.g., threads, processes, computing devices). In one example, the servers 1104 can house threads to perform one or more transformations. One possible communication between a client 1102 and a server 1104 can be in the form of a data packet adapted to be transmitted between two or more computer processes. The data packet can include, for example, a cookie and/or associated contextual information. The system 1100 can further include a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g. cookie(s) and/or associated contextual information). Similarly, the server(s) 1104 are operatively connected to one or more server data store(s) 1110 that can be employed to store information local to the servers 1104.

The claimed subject matter has been described herein by way of examples. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Additionally, the disclosed subject matter can be implemented as a system, method, apparatus, or article of manufacture using standard programming and/or engineering techniques to produce software, firmware, hardware, or any combination thereof to control a computer or processor based device to implement aspects detailed herein. The terms “article of manufacture,” “computer program product” or similar terms, where used herein, are intended to encompass a computer program accessible from any computer-readable device, carrier, or media. For example, computer readable media can include but are not limited to magnetic storage devices (e.g. hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, according to various permutations and combinations of the foregoing. Sub-components can also be implemented as components communicatively coupled to other components rather than included within parent components, e.g. according to a hierarchical arrangement. Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but generally known by those of skill in the art.

What is claimed is:

1. A system for de-interlacing a video sequence, comprising:
a texture classification component that determines an amount of texture in a block of an interlaced video frame and classifies the block based at least in part on the determination;
a motion detection component that analyzes the block to determine whether the block is in motion with respect to the video sequence; and
an interpolation component that estimates missing pixel data in the block based on a weighted combination of spatial interpolation and temporal interpolation, wherein the spatial interpolation and the temporal interpolation are weighted based at least in part on the classification of the block by the texture classification component and the determination of the motion detection component for the block.

2. The system of claim 1, wherein the texture classification component classifies the block as textured if determined that the block contains more than a threshold amount of texture or as non-textured otherwise.

3. The system of claim 2, wherein the motion detection component comprises a first motion detector for blocks classified as textured and a second motion detector for blocks classified as non-textured.

4. The system of claim 3, wherein the first motion detector computes at least two spatio-temporal sum of absolute differences (SAD) parameters and at least one temporal SAD parameter and determines whether a block is in motion based at least in part on the computed SAD parameters.

5. The system of claim 3, wherein the second motion detector computes at least two spatio-temporal SAD parameters and determines whether a block is in motion based at least in part on the computed SAD parameters.

6. The system of claim 1, wherein the interpolation component comprises:
a spatial interpolation component that interpolates pixel data in the block based on values of other pixels in a video field associated with the block;
a temporal interpolation component that interpolates pixel data in the block based on values of corresponding pixels in at least one of preceding or following video fields; and
a blending component that identifies a blending parameter and combines the pixel data interpolated by the spatial interpolation component and the temporal interpolation component based at least in part on the blending factor.

7. The system of claim 6, wherein the spatial interpolation component determines whether a pixel is located along a horizontal edge in its corresponding video field and interpolates the pixel using averaging upon a positive determination or vector matching upon a negative determination.

8. The system of claim 6, wherein the temporal interpolation component interpolates a value of a pixel based on values of respective pixels in a location corresponding to the pixel for which a value is interpolated in at least one of a preceding field or a following field.

9. The system of claim 6, wherein the blending component disregards the pixel data interpolated by the temporal interpolation component upon a determination by the motion detection component that the block is in motion.

10. The system of claim 6, wherein the blending component utilizes a first blending parameter upon a determination by the texture classification component that the block contains more than a threshold amount of texture and a second blending parameter upon a determination by the texture classification component that the block contains less than a threshold amount of texture.

11. A method of de-interlacing a video sequence, comprising:
identifying a block in an interlaced video frame;
determining an amount of texture in the block;
determining a degree of motion of the block with respect to the video sequence;
identifying a set of weighting factors based on at least one of the determined amount of texture in the block or the determined degree of motion of the block; and
de-interlacing the block by interpolating respective pixels therein utilizing a combination of spatial and temporal interpolation, wherein the combination is weighted using the identified set of weighting factors.

12. The method of claim 11, wherein the determining a degree of motion comprises determining the degree of motion of the block with respect to the video sequence based on spatial interpolation and temporal interpolation with an emphasis on temporal interpolation upon determining that the block has greater than a predetermined amount of texture.

13. The method of claim 12, wherein the identifying a set of weighting factors comprises identifying the set of weighting factors based on a temporal blending parameter.

14. The method of claim 11, wherein the determining a degree of motion comprises determining the degree of motion of the block with respect to the video sequence based on spatial interpolation and temporal interpolation with an emphasis on spatial interpolation upon determining that the block has less than a predetermined amount of texture.

15. The method of claim 14, wherein the identifying a set of weighting factors comprises identifying the set of weighting factors based on a spatio-temporal blending parameter.

16. The method of claim 11, wherein the identifying a set of weighting factors comprises assigning a zero weight to temporal interpolation upon determining that the degree of motion of the block with respect to the video sequence is greater than a predetermined value.

17. The method of claim 11, wherein the de-interlacing comprises performing spatial interpolation for respective pixels in the block at least in part by:
determining whether the respective pixels are located along a horizontal edge;
interpolating respective pixels found to be along a horizontal edge using vector matching; and
interpolating respective pixels found not to be along a horizontal edge using averaging.

18. The method of claim 11, wherein the de-interlacing comprises performing temporal interpolation for respective pixels in the block at least in part by:
identifying respective pixels at a location corresponding to a location of a pixel to be interpolated in one or more of a preceding field or a following field in the video sequence; and
averaging the respective identified pixels.

19. A computer-readable storage medium having stored thereon instructions operable to perform the method of claim 11.

20. A system that facilitates generating a progressive video sequence from an interlaced video sequence, comprising:
means for dividing a frame of the video sequence into blocks of uniform size;
means for providing a texture classification for a block by comparing a level of texture in the block to a predefined texture threshold;
means for classifying the block as moving or static by comparing a degree of motion in the block with respect to the video sequence to a predefined motion threshold;
means for estimating missing pixel values in the block using spatial interpolation based on the texture classification of the block upon the block being classified as moving; and
means for estimating missing pixel values in the block using a weighted combination of spatial interpolation and temporal interpolation based on the texture classification of the block upon the block being classified as static.
